(19) United States
(12) Patent Application Publication
(10) Pub. No.: US 2019/0042684 A1
(43) Pub. Date: Feb. 7, 2019

(54) Schematic Driven Analog Circuit Layout Automation

(71) Applicant: Oracle International Corporation, Redwood City, CA (US)

(72) Inventors: David L. Toub, Austin, TX (US); Larry B. Edwards, Sunnyvale, CA (US); Terry L. Maness, Albion, CA (US)

(21) Appl. No.: 15/667,277

(22) Filed: Aug. 2, 2017

(51) Int. Cl. G06F 17/50

(52) U.S. Cl. CPC G06F 17/5063; G06F 17/5068; G06F 17/505; G06F 17/5072; G06F 17/5036

(57) ABSTRACT

A method and apparatus for schematic driven analog circuit layout automation is disclosed. The method comprises a user providing input into schematic of an analog circuit presented in a circuit layout tool to group components into component groups. Responsive to the grouping of components, the circuit layout tool may automatically generate interconnections between components in each group, in accordance with the schematic. Based on user input, the groups may be moved to desired locations within a physical layout plan. Thereafter, the circuit layout tool may automatically generate interconnections between each of the groups, in accordance with the schematic. A physical layout plan may then be provided responsive to completing the generation of interconnections between groups.

### BACKGROUND

### Technical Field

This disclosure is directed to analog circuits, and more particularly, to the design and layout of analog circuitry in various environments, such as part of a printed circuit assembly (PCA) or on an integrated circuit (IC).

### Description of the Related Art

In designing analog circuits, one of the steps in finalizing the design is to perform a layout of the desired circuit. Performing a layout of a desired circuit may be automated using computer implemented circuit layout tools. Using such tools, a designer may generate a plan for a physical layout of an analog circuit to be implemented in, e.g., an integrated circuit (IC) or on a printed circuit assembly (PCA) that includes a printed circuit board (PCB). In the case where the analog circuit is to be implemented on an IC, a mask for manufacturing the same may be generated from the circuit layout tool. In the case where the analog circuit is to be implemented using a PCA, a design for a PCB may be generated, with the PCB design including areas for placing components of the analog circuit.

Circuit tools may specify certain design constraints from which the physical layout flows. Such constraints may include, e.g., sub-unit size, sub-unit location, and specific place and route options for components and interconnections, respectively. Beginning with these constraints, a designer using the circuit layout tool may select among the various options to generate a circuit layout plan that conforms to the design constraints. Generally speaking, these circuit layout tools may be layout-driven, i.e., conforming the circuit to the various options presented by the tools to generate a physical layout.

### SUMMARY

A method and apparatus for schematic driven analog circuit layout automation is disclosed. In one embodiment, a method comprises a user providing input into schematic of an analog circuit presented in a circuit layout tool to group components into component groups. Responsive to the grouping of components, the circuit layout tool may automatically generate interconnections between components in each group, in accordance with the schematic. Based on user input, the groups may be moved to desired locations within a physical layout plan. Thereafter, the circuit layout tool may automatically generate interconnections between each of the groups, in accordance with the schematic. A physical layout plan may then be provided responsive to completing the generation of interconnections between groups. A non-transitory computer readable medium storing program instructions implementing the circuit layout tool is also contemplated herein, as is a computer system having the circuit layout tool implemented on storage therein.

One embodiment of a method further includes updating one or more properties of at least one component in the schematic via user input. Responsive to updating properties of at least one component in a given group, the circuit layout tool may automatically re-generate placement of components within the group and interconnections there between. Furthermore, the spacing between component groups may be automatically adjusted in the physical layout plane. Upon completing the automatic adjusting of spacing between the groups, the interconnection between the component groups may be automatically re-generated, in accordance with the schematic.

Generally speaking, disclosure contemplates a method for generating a physical layout plan for an analog circuit that is schematic-driven, rather than layout-driven. That is, the method disclosed herein is not limited by the constraints typically associated with prior art solutions for performing analog circuit layout.

### BRIEF DESCRIPTION OF THE DRAWINGS

The following detailed description makes reference to the accompanying drawings, which are now briefly described.

FIG. 1 is an illustration of an integrated circuit (IC) and a printed circuit assembly (PCA) each implementing an analog circuit.

FIG. 2 is a schematic diagram of one embodiment of an analog circuit with components in selected groups.

FIG. 3 is a diagram illustrating an exemplary physical layout of the analog circuit of FIG. 2, without interconnects between groups and with interconnect between groups, in accordance with one embodiment of the disclosure.

FIG. 4 is a diagram illustrating another exemplary layout of the analog circuit of FIG. 2, with interconnects between groups, in accordance with one embodiment of the disclosure.

FIG. 5 is a flow diagram illustrating one embodiment of a method for performing a schematic-driven layout of an analog circuit using a circuit layout tool.

FIG. 6 is a flow diagram of one embodiment of a method for setting transistor group properties based on a mapping between transistors on a schematic and in a physical layout.

FIG. 7 is a flow diagram illustrating one embodiment of a method for performing an update of an analog circuit using a schematic as the main driver

FIG. 8 is a block diagram of one embodiment of a computer system and a non-transitory computer readable medium.

Although the embodiments disclosed herein are susceptible to various modifications and alternative forms, specific embodiments are shown by way of example in the drawings and are described herein in detail. It should be understood, however, that drawings and detailed description thereto are not intended to limit the scope of the claims to the particular forms disclosed. On the contrary, this application is intended to cover all modifications, equivalents and alternatives falling within the spirit and scope of the disclosure of the present application as defined by the appended claims.

This disclosure includes references to “one embodiment,” “a particular embodiment,” “some embodiments,” “various embodiments,” or “an embodiment.” The appearances of the phrases “in one embodiment,” “in a particular embodiment,” “in some embodiments,” “in various embodiments,” or “in an embodiment” do not necessarily refer to the same embodiment. Particular features, structures, or characteristics may be combined in any suitable manner consistent with this disclosure.

In the following description, numerous specific details are set forth to provide a thorough understanding of the disclosed embodiments. One having ordinary skill in the art, however, should recognize that aspects of disclosed embodiments might be practiced without these specific details. In some instances, well-known circuits, structures, signals, computer program instruction, and techniques have not been shown in detail to avoid obscuring the disclosed embodiments.

### DETAILED DESCRIPTION OF EMBODIMENTS

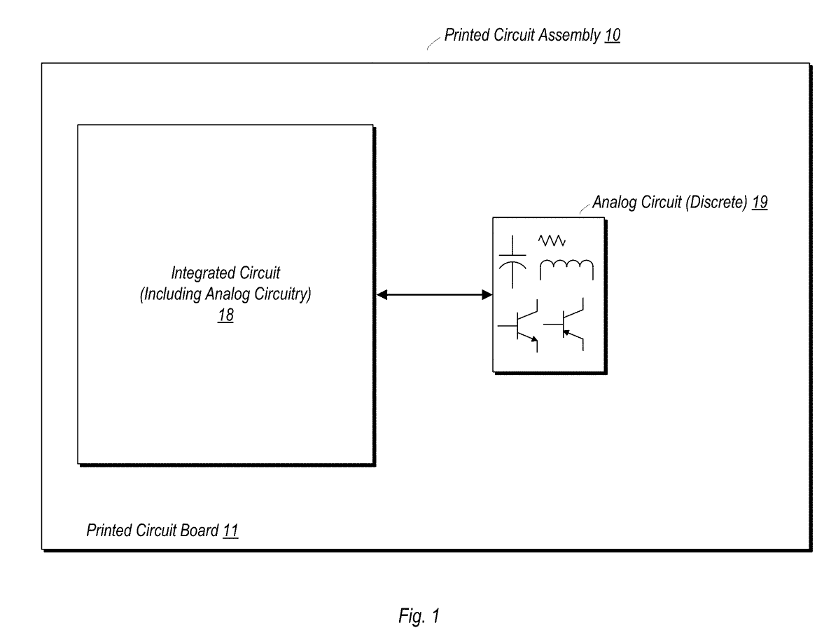

Turning now to FIG. 1, a drawing illustrating an exemplary embodiment of a printed circuit assembly is shown. It is noted that this embodiment is shown for the sake of illustration, but is not in any way intended to be limiting.

Printed circuit assembly (PCA) 10 in the embodiment shown includes an integrated circuit (IC) 18 implemented on a printed circuit board (PCB) 11. IC 18 in the embodiment shown includes analog circuitry, and may either be a fully analog IC, a mixed-signal IC, or generally, an IC with at least some analog circuitry implemented thereon. Additionally, PCA 10 in this embodiment includes at least one analog circuit 19 implemented with discrete components mounted on PCB 11.

The disclosure presented herein is generally directed to design tools for generating a layout of an analog circuit, either on an IC or with discrete components. Various embodiments of these design tools may enable generation of a physical layout of an analog circuit directly from a schematic. More particularly, the schematic may be used as the main driver of generating the layout, instead of focusing on the layout of an analog circuit in terms of various design constraints. Such tools may result in achieving a final, physical layout plan for an analog circuit in significantly less time than previous tools, which require various constraints to be set up to meet certain analog requirements.

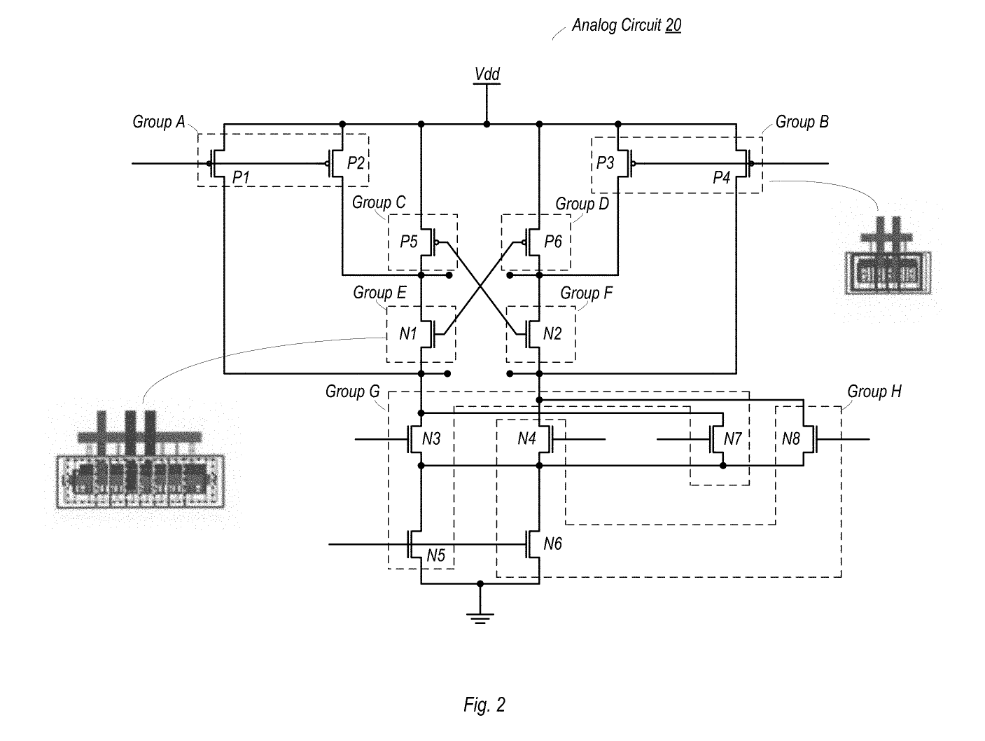

FIG. 2 is a schematic diagram of one embodiment of an analog circuit with components in selected group. More particularly, FIG. 2 one way in which transistors may be grouped in determining a physical layout for the analog circuit shown therein. Determining the grouping of various transistors (or more generally, components) in an analog circuit may be a first step in use of the layout tool disclosed herein.

In the embodiment shown, analog circuit 20 is a transistor-based analog circuit to be implemented on (or as part of) an IC. The circuit include a number of PMOS and NMOS transistors, each of which is part of a group. It is noted that these groups are but one of many possible groupings for the same circuit. It is further noted that while the exemplary circuit includes PMOS and NMOS transistors, the analog circuit layout tool discussed herein may be used with virtually any other types of analog components, including (but not limited to) bi-polar transistors, resistors, capacitors, diodes, inductors, and so on. The analog components may be discrete versions (e.g., for implantation on a PCB), or versions suitable for implementation on an IC.

Group A in the embodiment shown includes transistors P1 and P2, while Group B includes transistors P3 and P4. Groups C, D, E, and F each include one transistor only, namely P5, P6, N1, and N2, respectively. Group G includes transistors N3, N5 and N7, while Group H includes transistors N4, N6, and N8. In addition to illustrating one possible set of groupings, FIG. 2 also illustrates how some groups will appear when laid out in an IC, namely Group E and Group B.

The groupings may be determined by a user of the analog circuit layout tool. After selection of the groupings, the analog circuit layout tool may automatically generate interconnections between each of the components within a given component group in accordance with the schematic. For example, in Group G of the analog circuit 20 shown in FIG. 2, the source terminal of N3 is coupled to the drain terminal of N5, while both N3 and N7 have their drain terminals coupled to a common net of the circuit. These intra-group connections may be automatically generated upon selection and confirmation of the various groupings. Generally speaking, the analog circuit layout tool may generate intra-group connections for all components within a given group that have connections (e.g., share a common circuit net) with other components within the same group.

Once the intra-group connections are determined, the component groups may be placed at desired locations of a physical layout plan. In one embodiment, the movement of component groups to desired location may be based at least in part on user input. However, embodiments are possible and contemplated in which the placement of component groups in desired locations may be entirely automated.

After component groups have been placed in their desired locations, the analog circuit layout tool may automatically generate interconnections between the component groups, in accordance with the schematic of the circuit. For example, using the schematic of analog circuit 20 of FIG. 2, the analog circuit layout tool may automatically generate an interconnection between the drain terminal of transistor P5 (Group C) and the drain terminal of transistor N1 (Group E).

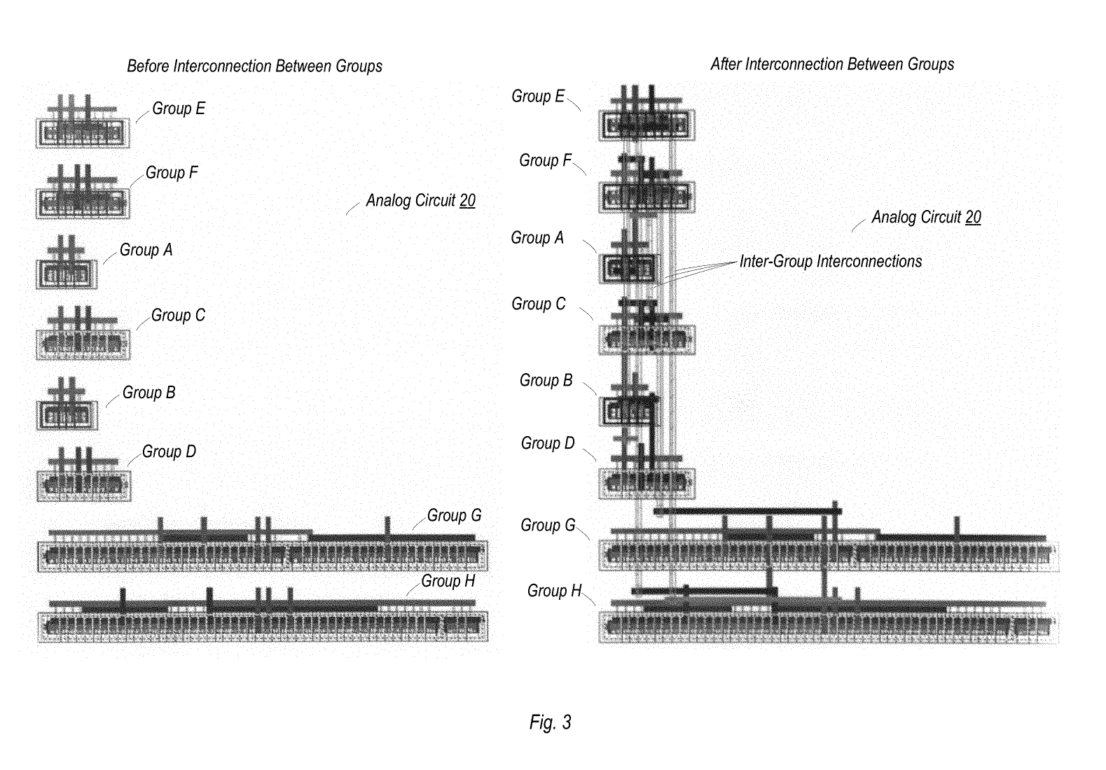

FIG. 3 illustrates one possible arrangement for the exemplary component grouping of FIG. 2. In particular, FIG. 3 illustrates the placement of the component groups before and after inter-group interconnections are generated. As shown in left-hand portion FIG. 3, the various exemplary groups of FIG. 2 are placed in desired locations within the layout. Once placed, the interconnections between groups may be generated. It is noted that the placement of the various component groupings shown here is one of many different possible group placements. As will be discussed below, other placements are possible and contemplated. In various embodiments of the analog circuit layout tool, selected component groupings may be re-arranged, in some cases without having to re-generate the interconnections within groups. For example, if the properties of individual components within a group are left unchanged (e.g., device sizes, parameter values, etc.), then the group may be moved within the physical layout while maintaining the previously generated intra-group interconnections.

The right-hand portion of FIG. 3 illustrates the physical layout after interconnections have been generated between the selected component groups. As with the generation of interconnections within groups, the generation of interconnections between groups may be performed based on and in accordance with the interconnections shown in the schematic of the analog circuit.

After generating the interconnections between groups, the analog circuit layout tool may output the physical layout plan, e.g., to a file, a display, and/or other medium. The analog circuit layout tool may also perform a layout vs. schematic (LVS) verification, to ensure that all interconnections between components (and groups thereof) are correct in accordance with the schematic. The LVS verification may also verify that the components of the circuit are implemented using the correct and specified properties (e.g., transistor sizes, types, etc.). As part of this verification, or in conjunction therewith, the analog circuit layout tool may also perform a simulation of the circuit as arranged in the physical layout plan in order to verify correct operation.

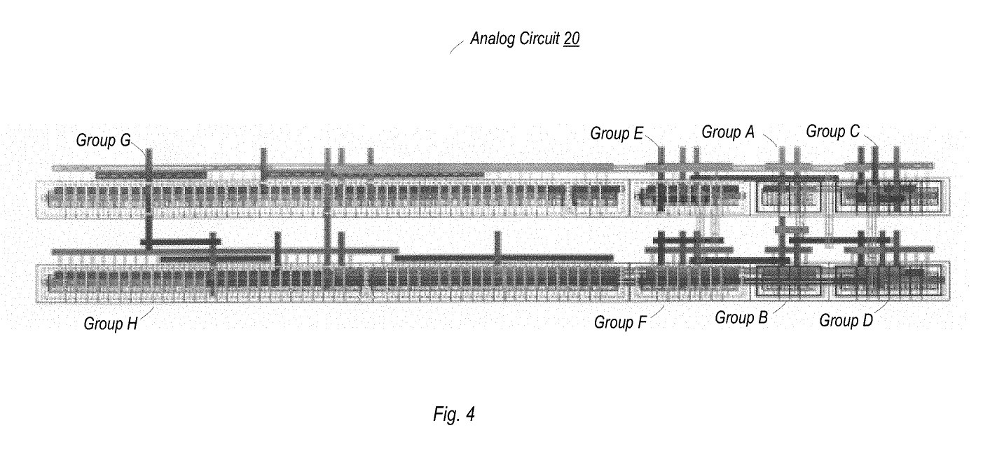

Turning now to FIG. 4, another exemplary layout of the analog circuit of FIG. 2 is illustrated. This exemplary embodiment includes interconnects between groups, and may be generated using the analog circuit layout tool as discussed herein.

The analog circuit layout tool as disclosed herein may allow the re-arrangement to be performed with or without having to re-generate interconnections within a given group. If no properties within a given component group are changed, the location of that component group within the physical layout may be changed while maintaining the previously generated intra-group interconnections. This in turn may enable a user to generate multiple, alternate physical layout plans for the same analog circuit as depicted in a given schematic. In one embodiment, the analog circuit layout tool may include a graphical user interface (GUI) that allows a use to select a given component group and change its location using a simple drag and drop operation.

If properties of components within a given group are changed, re-generation of the intra-group interconnections may be performed. Depending on the type and magnitude of changes to component properties, re-arrangement of the corresponding component groups may also be performed. Based on the ability to change properties within component groups, as well as the relative locations of component groups, the analog circuit tool may allow for updates to be performed for a given analog circuit per engineering change orders (ECOs). In addition to changing the properties of components within a group and changing the locations of component groups relative to one another, the analog circuit layout tool may also allow the changing of the component groupings for a given analog circuit as depicted in a schematic.

The analog circuit layout tool in one embodiment allows for cross-selection of groups, enabling them to be seen in both the schematic and in a physical layout plan generated therefrom. For example, a user of the analog circuit layout tool could, on the GUI of the tool, select Group F of the schematic and see the same group highlighted on the physical layout plan. The reverse is true as well, as the user could select a given component group of the layout plan and see that group highlighted on the schematic.

When a component group is selected, either through a displayed layout plan or a displayed schematic, the properties of components in the group may also be displayed. Thus, using the exemplary embodiments of FIG. 2 along with the layout of one of FIGS. 3 and 4, a use could select component Group E (either on the schematic or the physical layout plan) and the properties of each component in the group may be displayed.

Through the display of component properties, the tool may also provide an interface for changing properties of a component of a selected component group. Again, using the exemplary embodiment of the circuit shown in FIG. 2, selection of Group G may display the corresponding properties of transistors N3, N5, and N7. A user could then change properties of one of these components, e.g., a transistor size of at least one of them. After making this change, the analog circuit layout tool may re-generate the intra-group connections. The tool may also automatically make any necessary adjustments in the spacing between groups, and re-generate the inter-group connections. Alternatively, after re-generation of the intra-group connections, a user could, if desired, move component groups to different locations before re-generation of the inter-group interconnections.

The analog circuit layout tool may thus enable an iterative design process that uses the schematic as the primary driver. After generating at least an initial layout of an analog circuit, as described above, a user may make updates to the design through the tool. The user may select various component groups and make changes to various properties of components therein. A user may also change the component groupings if desired. After making any desired component and/or grouping changes, the tool may generate connections to other components within each group. A user may then using, e.g., a drag and drop interface, move the various components to desired locations. Alternatively, some embodiments of the tool may enable automatic placement of the component groups relative to one another. After placement of the various component groups, the tool may automatically generate inter-group interconnections. Thereafter, the physical layout may be extracted (output).

Operation of the analog circuit may also be simulated in accordance with the resulting layout. The simulation may include an LVS verification to ensure that the circuit of the layout matches that specified by the schematic. This verification includes determining that all interconnections are correct in accordance with the schematic. The LVS verification further includes determining that all components of each group are implemented in the layout in accordance with their properties as specified in the schematic. Simulation may also be used to determine other properties of the circuit, such as the correct and desired operation, timing, voltage levels on various nets, switching speeds, and other parameters to which a designer of the circuit may consider important.

If the LVS verification fails, or if the user desires to improve some aspect of the circuit (e.g., operation thereof, layout, etc.), another iteration may be performed, beginning with the selection of component groups and/or the re-grouping of components in the circuit.

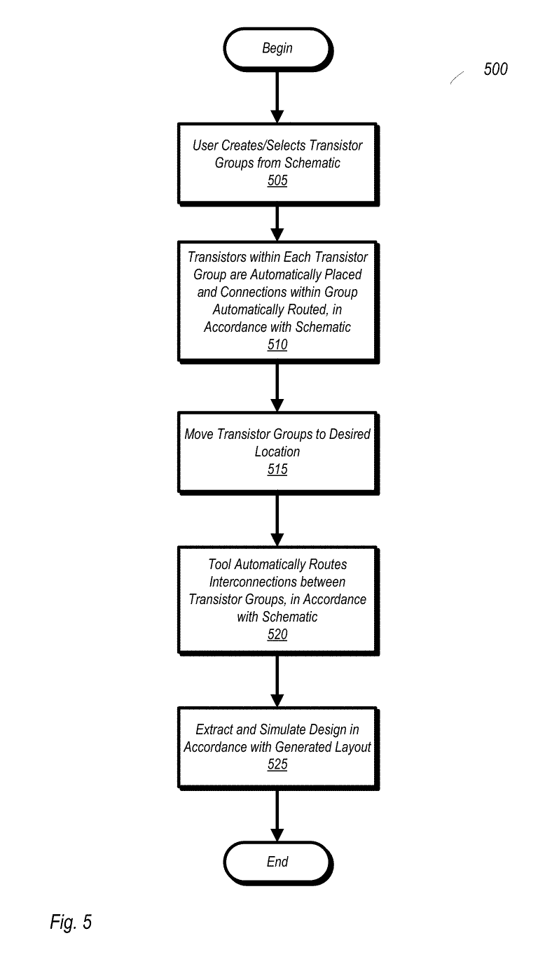

FIG. 5 is a flow diagram illustrating one embodiment of a method for performing a schematic-driven layout of an analog circuit using a circuit layout tool. Method 500 may be performed by various embodiments of an analog circuit layout tool as disclosed herein, and may be performed on a wide variety of systems. While method 500 as shown in FIG. 5 is discussed and illustrated in terms of the components being transistors, it is to be understood that this is exemplary and not intended to be limiting. In contrast, the methodology described herein may apply to virtually any type of analog circuit and any type of component used in an analog circuit. Accordingly, the transistor-centric embodiment discussed herein is only one embodiment of a more general method that may apply to analog circuits and components thereof of a wide variety of types, irrespective of whether they are explicitly mentioned herein.

Method 500 begins with a schematic of the analog circuit design, and a user creating/selecting transistor groups from the schematic (block 505). A user may use any desired criteria to group the transistors, such as type (e.g., PMOS vs. NMOS), size, circuit function, and so forth.

After settling on groupings of the transistors in the circuit, the method further includes placing each of the transistors within the group and routing interconnections there between (block 510). The routing of the interconnections between transistors of each group may be performed automatically by the analog circuit layout tool, and in accordance with the connections specified by the schematic.

The method further includes the moving of transistor groups to desired locations within the physical layout of the analog circuit (block 515). In one embodiment, the movement to transistor groups may be performed based on user input. For example, a user may, in a GUI, select a representation of a particular transistor group and perform a drag and drop operation to the desired location. This may be repeated for each of the designated transistor groups until all have been placed into respective locations of the physical layout plan. Embodiments are possible and contemplated wherein the placement of the transistor groups (or more generally, component groups) may be performed automatically by the analog circuit layout tool. In some embodiments, the placement of the various component groups may be performed in part manually, based on user input, and in part, automatically by the tool.

After placement of each of the transistor groups, the analog circuit layout tool may automatically generate interconnections between the groups, in accordance with the interconnections specified by the schematic of the circuit (block 520). The generation of inter-group interconnections includes routing of each such that they do not interfere with one another. The tool may also route interconnections based on other factors, e.g., the minimization of net length, among many other factors. In some embodiments, a user may specify factors to be considered in routing these interconnections, and may further prioritize factors relative to one another.

After the routing of the interconnections, the design of the physical layout for the circuit may be extracted, and operation of the circuit in accordance with the layout may be simulated (block 525). The simulation of the design may include LVS verification of the physical layout. The verification may include ensuring all interconnections, both within and between groups, is correct in accordance with the schematic. Additionally, the verification may also ensure that transistor (or more generally, component) properties in the physical layout match those of the schematic. The simulation may also include simulation of operation. The operational simulation of the circuit as implemented in the physical layout may allow a user to view various characteristics of the circuit operation, such as waveforms generated by the circuits, timing, magnitudes of signals on various nets/nodes, and so on. These characteristics may be selectable by a user.

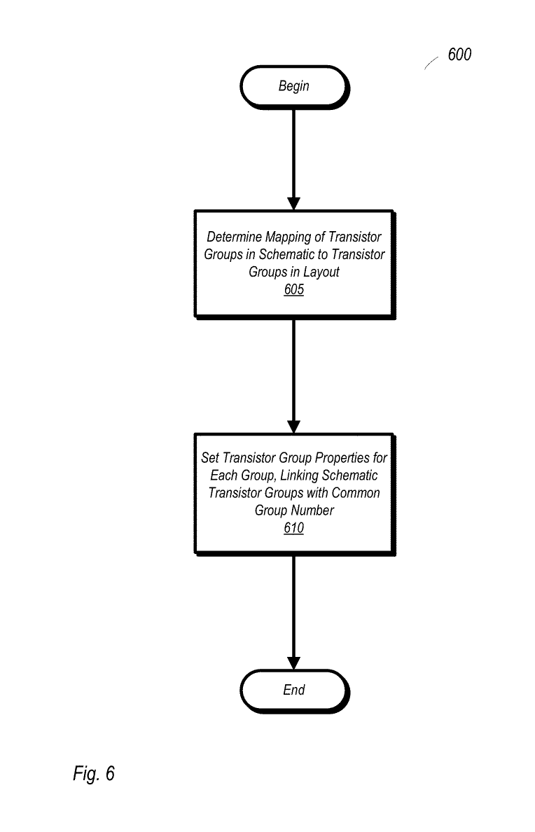

FIG. 6 is a flow diagram of one embodiment of a method for setting transistor group properties based on a mapping between transistors on a schematic and in a physical layout. Whereas the methodology illustrated in FIG. 5 begins with only a schematic of a circuit, that which is illustrated in FIG. 6 begins with a schematic and a physical layout of the circuit depicted therein. Method 600 may, in one embodiment, be the beginning of a design iteration for an analog circuit in which a physical layout has already been generated. For example, a change to an analog circuit made responsive to an ECO may, in some embodiments, begin with method 600.

It should noted that, like FIG. 5, method 600 is illustrated in terms of a transistor-based circuit. However, the methodology of FIG. 6 may apply more generally to any type of analog components and circuits implemented therewith, as the use of transistors in the illustrated embodiment is exemplary.

Method 600 begins with a user of the analog circuit layout tool determining a mapping of transistor groups in a schematic to corresponding transistor groups of a physical layout of the circuit (block 605). In one embodiment, a GUI of the analog circuit layout tool may graphically display both the schematic of a circuit, with transistor groups designated, and a corresponding physical layout plan. A user may select, through the GUI (e.g., by point a cursor with a mouse) a transistor group in the schematic. Responsive thereto, the tool may highlight the corresponding transistor group in the physical layout. The tool may also enable a user to select, through the GUI, a transistor group in the physical layout, with the response being the highlighting of the corresponding group in the schematic. Using this feature, a user may determine the one-to-one mapping between each transistor group as depicted in the schematic and as arranged in the physical layout.

Method 600 also includes user setting group properties for each group in the schematic, and linking the groups in the schematic and those in the layout with a common group number (block 610). Setting the group properties may include setting properties for individual transistors (or more generally, components) with the groups. In some cases, properties for components in a particular group may remain unchanged. However, some or all components within a group may be changed during this process. Virtually any property applicable to a given component may be changed. Using transistors as an example, properties that may be changed include the size of various features (e.g., gate length, oxide thickness, etc.), electrical parameters (e.g., threshold voltages) and so on.

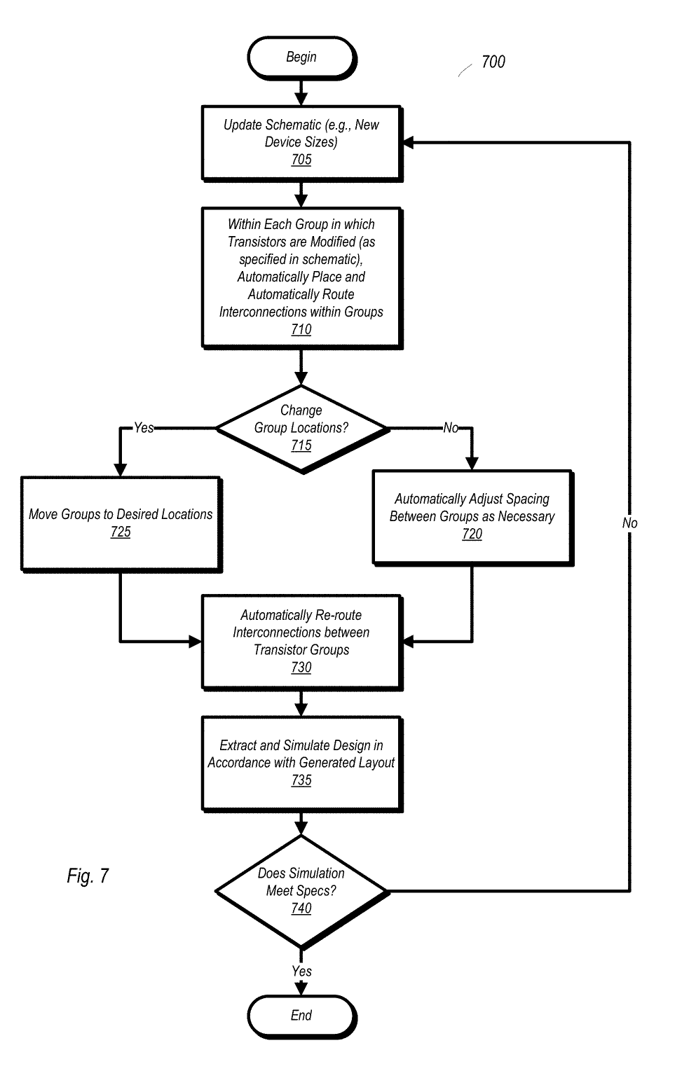

After completing method 600, the remainder of the process for generating a physical layout may be conducted. One embodiment of an overall process for generating a physical layout from a pre-existing design (e.g., responsive to an ECO for an analog circuit for which a previous layout was generated) is now illustrated in FIG. 7. Method 700 of FIG. 7, like methods 500 and 600 of FIGS. 5 and 6, respectively, is expressed in terms of the components being transistors. However, like those methods, method 700 as shown in FIG. 7 may be more generally applicable to virtually any type of analog component and for virtually any type of analog circuit. Accordingly, for any of methods 500, 600, and 700, terms such as “component” or “analog circuit component” may be used to replace the use of “transistor” in these exemplary embodiments.

Method 700 begins with the updating of a schematic (block 705). The updating of the schematic may, in one embodiment, be performed in accordance with method 600 of FIG. 6. Thus, the method may include changing properties of the transistors within various groups. Such properties, as noted above, may include various feature sizes, various electrical parameters, or any other applicable property.

After transistors within a given group have been modified, the analog circuit tool may automatically place the transistors within the group and automatically route interconnections there between (block 710). This may be performed for any group in which at least one transistor has been modified. In groups in which no transistors have been modified, the layout (including interconnections) may remain unchanged, with the circuit layout tool performing no actions on these groups. In groups where only a single component is present (and thus there are no interconnections between two or more components), any adjustments necessitated by a change of properties (e.g., the location of connection points of the singular component) may be updated.

If the user desires to change the locations of the transistor groups relative to one another (block 715, yes), then the user may move the groups to their new locations (block 725). As noted above, this may be performed manually by a user through a GUI, e.g., by dragging and dropping selecting groups to their respective locations as desired. Embodiments are possible and contemplated in which the tool may automatically place the groups at this point in the methodology.

If the user does not desire changes to the locations of the transistor groups or otherwise prefers to maintain the general physical layout as established (block 715, no), the analog circuit layout tool may automatically adjust the spacing between the groups as necessary (block 720). Such changes may be necessitated by, e.g., changes to the size of transistors or features thereof within a group and thus changes to the overall size and locations of connection points. In some cases, some movement of groups may in some be unavoidable, although the automatic adjustment of spacing between the groups may in some embodiments be performed as to minimize such changes.

After either the groups have been moved or spacing there between has been adjusted, the interconnections between groups may be generated (block 730). As previously noted, the connections between the groups (and thus, between transistors/components of one group to those of another) may be generated in accordance with those specified by the schematic. Generating these connections includes, in addition to connecting components of different groups, routing the connections such that they do not interfere with one another, while also minimizing the area they consume.

Once the interconnections between groups have been generated, the layout may be extracted (output) and simulated (block 730). The simulation may include LVS verification, ensuring that all device properties and interconnections conform to those of the schematic. The simulation may also include simulation of the operation of the circuit as in the generated layout. The simulation may generate various types of data, including visual waveforms, data regarding voltages, currents, and other electrical parameters at various nodes, and so on. Using the LVS verification information and the data generated from simulating operation of the circuit as in the layout, a user may determine if the simulation meets specifications (block 730). The specifications may be firm specifications from design requirements, but may also include judgment from the user as to whether the circuit can perform better by some metric with additional design iterations. If the user determines that specifications have not been met, or otherwise would like to further refine the design/layout (block 740, no) the method may return to block 705 and the user may perform another iteration of the layout process. Otherwise, if the specifications have been met and the user is satisfied with the design, the method may be considered complete.

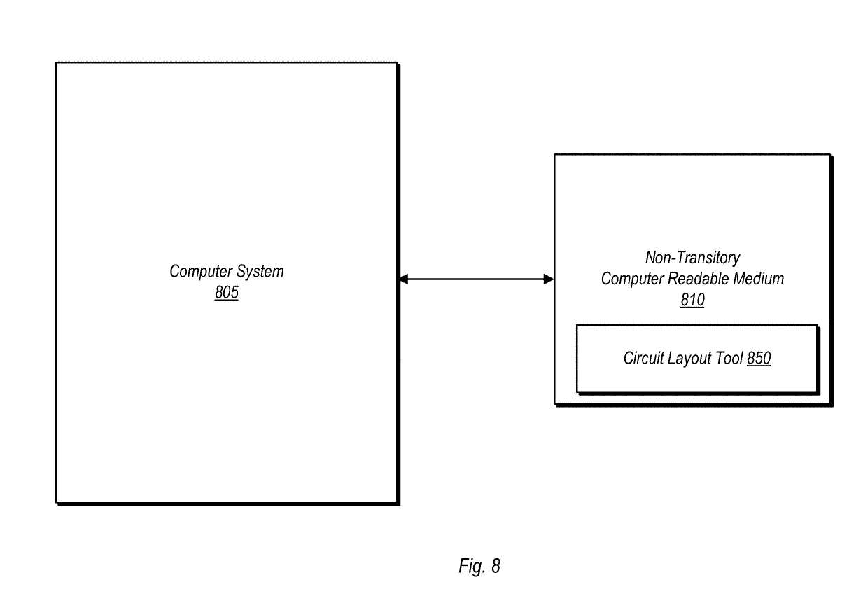

FIG. 8 is a block diagram of one embodiment of a computer system and a non-transitory computer readable medium. Computer system 805 in the embodiment may be one of a number of different types of computer systems that may execute instructions of the analog circuit layout tool. Such computer systems include, but are not limited to, desktop computers/workstations, laptop computers, as well as tablets and mobile devices.

Computer system 805 may include, or may be coupled to, non-transitory computer readable medium 810. This computer readable medium may be one of a number of different types of non-transitory storage, including flash memory, CD-ROM, various types of RAM/SRAM, hard disk/bulk storage, or any other suitable storage medium that may be read by a computer system.

Stored on computer readable medium in the embodiment shown is analog circuit layout tool 850, which may include instructions executable by computer system 805 to perform the various tasks discussed above. Additionally, the analog circuit layout tool may include one or more databases. These databases may include information on various components, materials used in the actual physical implementation of analog circuits, and so on. These databases may include interfaces that allow modification by users of the analog circuit layout tool. For example, a user may modify a component database to add new components thereto. The analog circuit layout tool 850 may also be operable to perform file storage, such as storage of data pertaining to physical layouts of analog circuits, and information for manufacturing the same.

Although not explicitly shown, computer system 805 may include, or may be coupled to, one or more output devices. Such output devices may include a display terminal, a portion of a network card configured for transmitting information, a storage medium that is both writeable and portable, or a printer, among other possible examples. Through such an output device, computer system 805 may output a physical layout plan for an analog circuit as generated by the analog circuit layout tool 850. Such a plan may be in one of a number of different file formats, and may include multiple files, at least some of which may be different formats than others. The layout plan for a given analog circuit as generated by analog circuit layout tool 850 and output from computer system 805 may be useable to manufacture the analog circuit. For example, the layout plan may be receivable by equipment used for manufacturing analog and/or mixed signal integrated circuits or generating masks for the same. Using files that include the layout plan, integrated circuit masks may be generated and the circuit may be manufactured. In general, computer system 805 may output any type of information in any type of format that is usable to manufacture a layout of an analog circuit generated by the analog circuit layout tool, as well as understanding the layout of the same and the construction of the circuit in terms of components and materials.

Numerous variations and modifications will become apparent to those skilled in the art once the above disclosure is fully appreciated. It is intended that the following claims be interpreted to embrace all such variations and modifications.

What is claimed is:

1. A method comprising:
in a circuit layout tool, grouping components of a schematic of an analog circuit into one or more component groups, wherein grouping of components is performed based on user input to the circuit layout tool;
automatically generating, using the circuit layout tool, interconnections between components in each of the component groups in accordance with the schematic of the analog circuit;
moving, by the circuit layout tool the component groups to a respective locations of a physical layout plan;
automatically generating, using the circuit layout tool, interconnections between each of the component groups in accordance with the schematic of the analog circuit; and
outputting the physical layout plan for the analog circuit responsive to completing automatically generating interconnections between each of the component groups.

2. The method as recited in claim 1, further comprising:
updating, in the circuit layout tool, one or more properties of one or more components in the schematic;
automatically generating, using the circuit layout tool, interconnections between components in each of the component groups that includes a component for which one or more properties was modified;
automatically adjusting, in the physical layout plan, spacing between component groups responsive to updating one or more properties of the one or more components; and
automatically re-generating interconnections between the component groups.

3. The method as recited in claim 2, wherein the analog circuit includes one or more transistors, and wherein one or more properties of one or more components in the schematic includes updating at least one property of at least one of the one or more transistors.

4. The method as recited in claim 2, further comprising re-arranging of one or more of the component groups in the physical layout plan, wherein interconnections between components in each of the component groups are maintained during the re-arranging.

5. The method as recited in claim 2, further comprising automatically re-arranging physical placement of components in each of the component groups that includes a component for which one or more properties was modified.

6. The method as recited in claim 1 further comprising automatically placing components of each component group within the physical layout plan.

7. The method as recited in claim 1, further comprising simulating operation of the analog circuit as arranged in the physical layout plan.

8. The method as recited in claim 1, further comprising performing a layout vs. schematic verification, wherein performing the layout vs. schematic verification includes determining if circuit interconnections in the physical layout plan match circuit interconnections of the analog circuit as depicted in the schematic.

9. A non-transitory computer readable medium storing instructions thereon that implement an analog circuit layout tool, wherein the instruction of the analog circuit layout tool, when executed by a computer system, cause the computer system to:
group components of a schematic of an analog circuit into one or more component groups based on user input, wherein grouping of components is performed based on user input to the circuit layout tool;
automatically generate interconnections between components in each of the component groups in accordance with the schematic of the analog circuit;
move the component groups to a respective physical locations;
automatically generate interconnections between each of the component groups in accordance with the schematic of the analog circuit; and
output a physical layout plan for the analog circuit responsive to completing automatic generation of interconnections between each of the component groups.

10. The computer readable medium as recited in claim 9, wherein the analog circuit layout tool includes further instructions that when executed by the computer system and responsive to a user updating one or more properties of one or more components in the schematic, cause the computer system to:
automatically re-generate interconnections between components in a given component group that includes at least one component for which one or more properties was modified;
automatically re-generate physical placement for each component, relative to other components in the given component group; and
automatically re-generate interconnections between components in the given component group in accordance with the schematic of the analog circuit.

11. The computer readable medium as recited in claim 10, wherein the analog circuit layout tool includes further instructions that when executed by the computer system and responsive to a user updating one or more properties of one or more components in the schematic, cause the computer system to:
automatically adjust, in the physical layout plan, spacing between component groups responsive to updating one or more properties of the one or more components.

12. The computer readable medium as recited in claim 11, wherein the analog circuit layout tool includes further instructions that when executed by the computer system cause the computer system to automatically re-generate interconnections between the component groups.

13. The computer readable medium as recited in claim 9, wherein the analog circuit layout tool includes further instructions that when executed by the computer system, cause the computer system to automatically place components of each component group within the physical layout plan.

14. The computer readable medium as recited in claim 9, wherein the analog circuit layout tool includes further instructions that when executed by the computer system, cause the computer system to simulate operation of the analog circuit as arranged in the physical layout plan.

15. The computer readable medium as recited in claim 9, wherein the analog circuit layout tool includes further instructions that when executed by the computer system, cause the computer system to:
perform a layout vs. schematic verification, wherein performing the layout vs. schematic verification includes determining if circuit interconnections in the physical layout plan match circuit interconnections of the analog circuit as depicted in the schematic.

16. A computer system comprising:
a non-transitory storage medium storing thereon an analog circuit layout program, wherein the analog circuit layout program includes instructions that, when executed by a processor of the computer system, cause the computer system to:
group components of a schematic of an analog circuit into one or more component groups based on user input, wherein grouping of components is performed based on user input to the analog circuit layout program;
automatically generate placement of components in each of the one or more component groups relative to other components in a same one of the one or more component groups;
automatically generate interconnections between components in each of the component groups in accordance with the schematic of the analog circuit;
move the component groups to a desired physical location based on user input;
automatically generate interconnections between each of the component groups in accordance with the schematic of the analog circuit; and
output a physical layout plan for the analog circuit responsive to completing automatic generation of interconnections between each of the component groups.

17. The computer system as recited in claim 16, wherein the storage medium includes instructions that, when executed by a processor of the computer system, cause the computer system to update the physical layout plan responsive to one or more user-initiated changes to properties of at least one component in the schematic of the analog circuit.

18. The computer system as recited in claim 17, wherein the storage medium includes instructions that, when executed by a processor of the computer system, cause the computer system to automatically re-generate placement of each component relative to other components in a given one of the component groups responsive to a change of one or more properties to at least one component in the given one of the component groups.

19. The computer system as recited in claim 18, wherein the storage medium includes instructions that, when executed by a processor of the computer system, cause the computer system to automatically re-generate interconnections between components of the given one of the component groups responsive to re-generating placement of each component relative to other components in the given one of the component groups.

20. The computer system as recited in claim 19, wherein the storage medium includes instructions that, when executed by a processor of the computer system, cause the computer system to:
automatically adjust, in the physical layout plan, spacing between component groups responsive to one or more user-initiated changes to properties of at least one component in the schematic of the analog circuit; and
automatically re-generate interconnections between the component groups responsive to automatically adjusting spacing between component groups.
